(19) United States
(12) Patent Application Publication
(10) Pub. No.: US 2025/0115318 A1
(43) Pub. Date: Apr. 10, 2025

(54) BICYCLE STAND

(71) Applicant: Portineer, LLC, Fairport, NY (US)

(72) Inventor: Terrell Teague, Rochester, NY (US)

(73) Assignee: Portineer, LLC, Fairport, NY (US)

(21) Appl. No.: 18/909,331

(22) Filed: Oct. 8, 2024

Related U.S. Application Data
(60) Provisional application No. 63/543,379, filed on Oct. 10, 2023.

(51) Int. Cl. B62H 3/08; B60R 5/04

(52) U.S. Cl. CPC B62H 3/08; B60R 5/04

(57) ABSTRACT

An improved bicycle carrier is suitable for holding and facilitating the storage and transport of a bicycle in a horizontal or vertical position. The disclosed embodiments each include a structure to not only reliably secure the bicycle's components, but also to protect critical components such as a derailleur.

This application claims priority under 35 U.S.C. § 119(e) to U.S. Provisional Patent Application No. 63/543,379, for a BICYCLE STAND, filed Oct. 10, 2023 by Portineer, LLC (Applicant) and Terrell K. Teague (Inventor), which is hereby incorporated by reference in its entirety.

Disclosed are improved bicycle stand embodiments suitable for holding and facilitating the storage and transport of a bicycle in a horizontal and vertical position such as a vehicle cargo area or truck bed, including an embodiment facilitating the storage and transport of a bicycle in an adjustable angled position.

### BACKGROUND & SUMMARY

At the present time it is known to transport bicycles using various types of motor vehicles such as cars, vans, trucks, and buses. Many examples of known devices focus on transporting a bicycle on the exterior of a vehicle. Such examples are bicycle racks mounted on the trunk of a car or roof of a vehicle like the device disclosed in U.S. Pat. No. 4,442,961. This device captures the tires of the bicycle and affixes it in an upright position. Other devices provide means to fix a bicycle to the bed of a pickup truck or floor of a vehicle for transport such as German Patent DE 202006006847 U1. This device works by capturing the bicycle fork in the same way the front tire is mounted to the bicycle. The disadvantage of this device is that it does not provide for removing or storing the front tire. In a similar fashion, the device disclosed in U.S. Pat. No. 6,382,480 captures the fork of the bicycle and provides an extendable tray that aids in the loading of the bicycle into the vehicle. Another device disclosed in Chinese Patent WO 2014/071549 A1 does address the storage of the front wheel and it also features wheels to aid in the loading of the bicycle into a vehicle. However, the aforementioned devices require the bicycle to be in an upright position which, for some vehicles cannot work due to space constraints. For those instances, loading the bicycle in a horizontal or sideways fashion would be more conducive to fitting in the cargo area of a vehicle.

Germany patent DE 9312946 U1 discloses a device to place a bicycle in a vehicle at an angle. However, it requires the user to remove the front tire and has no provisions for storage of the removed tire. The angle at which the bicycle is held is fixed limiting usefulness across various situations and cargo areas. Also, the device is meant to remain in the vehicle while loading so would not be useful for a general stand outside a vehicle.

There are other publications that disclose the transportation of a bicycle on its side in the interior of a vehicle. One such example is U.S. Patent Application US2022/0119058 A1 which is a device to protect the bicycle's back components (e.g., derailleur) while laying on its side inside a vehicle. Shortcomings of this apparatus is that it has no previsions for securing the bicycle's front tire if needed to be removed for the bicycle to fit into the vehicle, and it also does not aid the user in getting the bicycle in the vehicle. Nor does it capture the front end of the bicycle, where sensitive components could be displaced or damaged during transport. Furthermore, laying the bicycle on its side prevents the user from utilizing the space more effectively when more height is available, such as in a van or SUV.

Another example is U.S. Pat. No. 11,505,132 which features a mechanism on a sliding rail to capture the chain stay and seat stay tubing of a bicycle to aid a user in loading a bicycle into a vehicle horizontally. A disadvantage of this design is that it does not address the storage of the front tire or its removal when the bicycle is in the horizontal position. This device does allow for the bicycle to be mounted in a vertical position with or without the front tire attached, but the user must reattach the device to switch between the horizontal and vertical position and vice versa. Furthermore, if the bike is attached in the vertical position with the front tire removed, there are no provisions to store the front tire.

To date, there does not appear to be any disclosure or production of a device that aids the user in removing the bicycle front tire for transport, captures the removed tire, facilitates the loading of a bicycle in a horizontal or near-horizontal position, and that also protects the bicycle during transportation. Furthermore, no known apparatus allows the user to switch between the bicycle being stored in an upright or horizontal position without having to reattach the device to the vehicle.

In view of the foregoing discussion and noted disadvantages inherent in the various bicycle transportation devices, a device in accordance with one or more of the disclosed embodiments is proposed, providing solutions that that assist an operator in the removal and storage of a bicycle front tire and capturing the bicycle(s) in such a manner that the bicycle(s) can be easily laid down horizontally (or nearly horizontal) while protecting the bicycle's components from displacement or damage. With additional features to aid the operator in loading the bicycle in a vehicle's interior such as a cargo area for transportation in an angled or even a horizontal position. The device can be used to store a bicycle in the horizontal or vertical position, or angles therebetween, without needing reattachment. Furthermore, the device positions and captures the bicycle forks in a right-angle fashion to minimize the space envelop the bicycle takes up while stored or transported.

Disclosed in embodiments herein is a bicycle carrier apparatus for securely storing a bicycle within a vehicle or storage space, comprising: a carrier trough having a profile shaped to engage the tires of the bicycle; a first strut and a second strut connected by a strut joint, the strut joint further adjustably attaching the first strut and the second strut to the carrier trough, wherein the length of said second strut is sufficient to provide an adequate tether angle without adversely affecting the overall height of the bicycle carrier apparatus; and an upper tether and a lower tether, respectively attached to said second strut and said first strut, each tether equipped with a tether hook and a tether tightener to secure the bicycle in contact with said carrier trough.

Further disclosed in embodiments herein is a bicycle carrier apparatus including: a longitudinal member having a reduced friction member operatively associated with one end thereof; at least one rigid mechanical member attached to and extending in a generally perpendicular direction from the longitudinal member; at first adjustable component to releasably secure a rear wheel of a bicycle relative to at least the longitudinal member; and a second component to releasably secure a front wheel of the bicycle relative to at least the longitudinal member.

### BRIEF DESCRIPTION OF THE DRAWINGS

In the drawings, related elements may have the same number but different alphabetic suffixes.

FIG. 1 is an isometric view from the top and left of a bicycle carrier embodiment;

FIG. 2 is a view from the left of the bicycle carrier embodiment;

FIG. 3 is a view from the right of the bicycle carrier embodiment;

FIG. 4 is a view from the top of the bicycle carrier embodiment;

FIG. 5A shows an isometric view of an optional fork and wheel mount, and FIG. 5B is an isometric view from the top and left of the bicycle carrier embodiment shown with the optional fork and wheel mount attached;

FIG. 6 is an isometric view from the top and left of the bicycle carrier embodiment with a bicycle mounted on it in a near vertical position;

FIG. 7 shows a front view of the bicycle carrier embodiment with a bicycle mounted on it in a near vertical position;

FIG. 8 shows a front view of the bicycle carrier embodiment with a bicycle mounted on it in a near horizontal position;

FIG. 9 shows a front view of the bicycle carrier embodiment with a bicycle mounted on it in a near horizontal position with handlebar turned 90 degrees;

FIG. 10 shows an isometric view from the top and left of the bicycle carrier embodiment with a bicycle mounted on it in a near vertical position with optional fork and wheel mount;

FIGS. 11A and 11B show alternative views of the bicycle carrier embodiment with bicycles mounted in a near horizontal position inside an SUV type vehicle;

FIG. 12A is isometric view from the top and left of the bicycle carrier embodiment, and FIG. 12B is an expanded view of the detail of the strut joint of FIG. 12A;

FIG. 13A is an isometric view of the trough profile for the bicycle carrier embodiment, and FIG. 13B is a detailed view of a portion of FIG. 13A;

FIG. 14 shows an isometric view from the top and left of an alternative bicycle stand embodiment;

FIG. 15 shows a view from the left of the alternative bicycle stand embodiment;

FIG. 16 shows a view from the right of the alternative bicycle stand embodiment;

FIG. 17 shows an isometric view from the top and right of the alternative bicycle stand embodiment;

FIG. 18 shows a view from the top of the alternative bicycle stand embodiment;

FIG. 19 shows a view from the left of the alternative bicycle stand embodiment in an upright position with a bicycle mounted on it;

FIG. 20 shows a view from the right of the alternative bicycle stand embodiment in an upright position with a bicycle mounted on it;

FIG. 21 shows a view from the front of the alternative bicycle stand embodiment in an upright position with a bicycle mounted on it;

FIG. 22 shows a view from the top of the alternative bicycle stand embodiment in an upright position with a bicycle mounted on it;

FIG. 23 shows an isometric view from the top and right of the alternative bicycle stand embodiment in an upright position with a bicycle mounted on it;

FIG. 24 shows an isometric view from the top and left of the alternative bicycle stand embodiment in an upright position with a bicycle mounted on it;

FIG. 25 shows a view from the right of the alternative bicycle stand embodiment with a bicycle mounted on it for wheel removal;

FIG. 26 shows a view from the side of the alternative bicycle stand in the horizontal position with a bicycle mounted on it;

FIG. 27 shows a view from the side of the alternative bicycle stand in the horizontal position with a bicycle mounted on it as it would be loaded into a car;

FIG. 28 shows an isometric view of three bicycle stands connected to a multi-mount strut detail;

FIG. 29A shows an isometric view of three bicycle stands connected to a multi-mount strut, and FIG. 29B is an expanded view of the detail of the multi-mount strut of FIG. 29A; and

FIG. 30 shows an isometric view of three bicycle stands connected to a multi-mount strut in a pickup truck.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

In the following description, the various embodiments are characterized as a bicycle carrier for use with a bicycle. However, it will be appreciated that the disclosed bicycle carrier could also be used for other similar devices such as E-bikes, motorized bicycles and even motorcycles. Accordingly, reference to the term “bicycle” is not intended to be limited to self-propelled devices, but includes glide-bikes, E-bikes, motorized bicycles and even motorcycles.

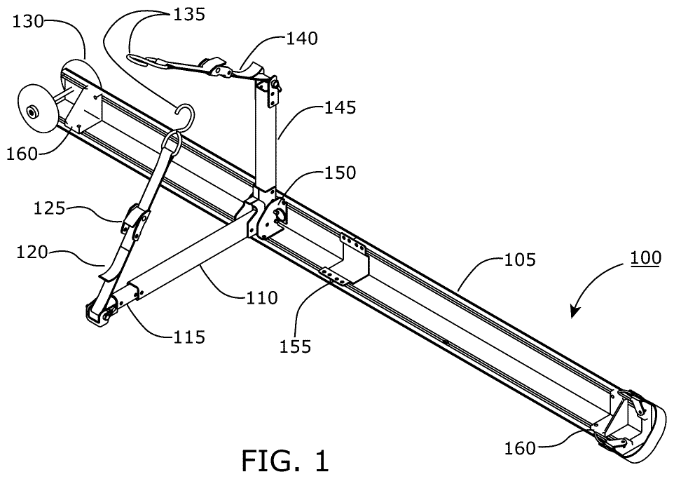

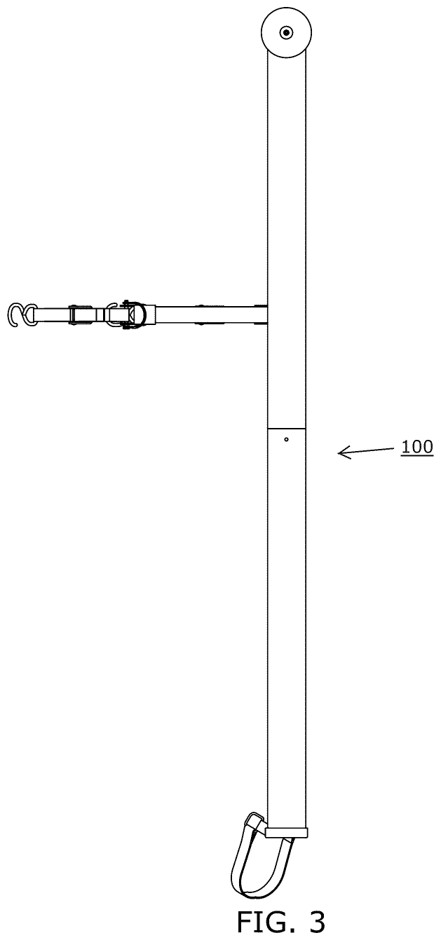

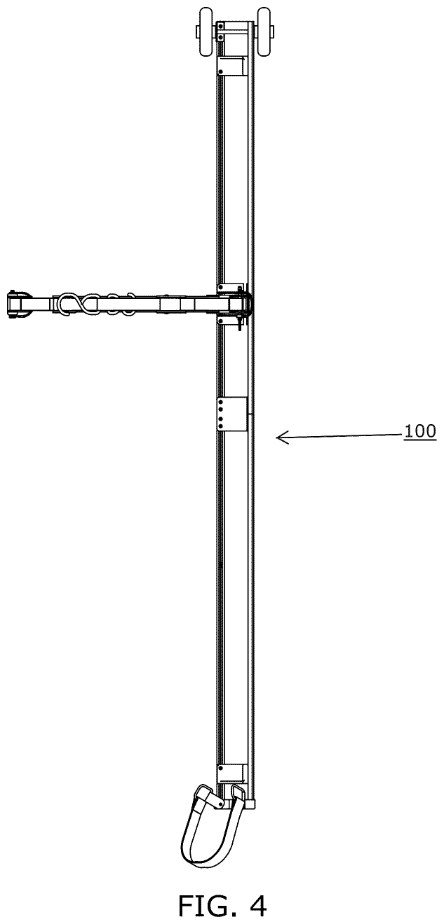

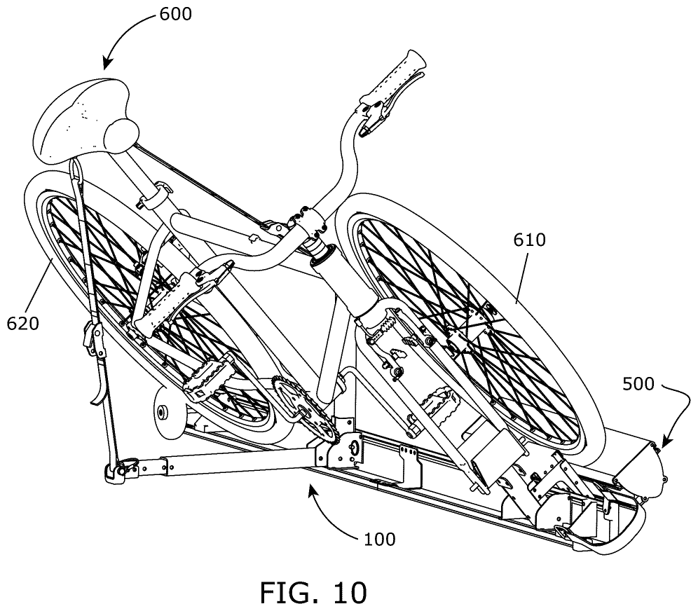

Referring to FIGS. 1-13B, the illustrated embodiment of a first bicycle carrier embodiment 100 generally includes a carrier trough 105 which is the approximate length of a bicycle 600. The carrier trough 105 as depicted in FIG. 1 has a generally L-shaped profile consistent with 90-degree metal angle stock. The L-shaped profile is used to capture the tires of bicycle 600 and to provide a pivot point between the bicycle 600 and the carrier trough 100 wherein the pivot point is at the point of contact of bicycle 600 and carrier trough 105 trough bottom. It should be noted that the carrier trough 105 profile shape could be in other forms including a rounded bottomed trough, a V-shaped trough, or other concave geometry providing central tire alignment and facilitating angular adjustment of the bicycle within said carrier trough as such to locate the tires (front tire/wheel 610, rear tire/wheel 620) of bicycle 600 centrally and allow for the pivot of the bicycle 600 when placed into the trough.

Rigidly attached to carrier trough 105 is an L-shaped structure made up of horizontal strut 110, horizontal strut extension 115, vertical strut 145 and strut joint 150. The length of vertical strut 145 is short enough that it does not contribute adversely to the overall height (H) of the combination of the bicycle carrier 100 and bicycle 600 assembly when bicycle 600 is installed at a near-horizontal angle while tall enough to provide an adequate tether angle (117 and 147 relative to horizontal strut 110 with extension 115, and vertical strut 145, respectively) so as not to create more force than the construction materials and configuration of bicycle carrier 100 and bicycle 600 can accommodate in the near horizontal position. The length of horizontal strut 110 and horizontal strut extension 115 are such that the combination of horizontal strut 110 and horizontal strut extension 115 can be made short enough as to not contribute adversely to the overall width of the combination of bicycle carrier 100 and bicycle 600 assembly when bicycle 600 is installed at a near vertical angle, but can be made long enough such that it provides support out past the center of gravity of bicycle 600 when the bicycle is installed at a near horizontal angle (relative to the cargo area floor or truck bed) preventing tipping of the overall assembly. It should be noted that the connection point of the vertical strut 145 and horizontal strut 110 to the strut joint 150 is optimally at the same point along the carrier trough 105 to minimize rotational torque on bicycle 100, the vertical strut 145 and horizontal strut 110 connection points could be at different locations along carrier trough 105. This situation may allow more efficient use of space, less manufacturing cost or accommodate other bicycle designs.

Attached to the end of the vertical strut 145, opposite of the strut joint 150, is the upper tether 140. Upper tether 140 is constructed of flexible webbing strap material and features a loop or hook or similar means at its strut connection end to attach to the end of vertical strut 145. The other end of upper tether 140 features a device to connect to features on bicycle 600. In the illustrated embodiment a tether hook 135 is employed. Tether tightener 125, such as a ratchet, buckle, or other adjustable mechanical fastener, is employed to allow the length of upper tether 140 to change and, once adjusted, held to the desired length. It should be noted that other materials could be used in the construction of upper tether 140 such as but not limited to wire or fiber rope, chain or telescopic tubing if the same function is provided. It should also be noted that other means to tighten the upper tether 140 and lower tether 120 could be but is not limited to a ratcheting device, buckle, chain hooks or mechanical fasteners. Further contemplated is an embodiment where a single tether replaces the upper and lower tethers, and while having a component to releasably attach or hold the tether relative to the bicycle frame, it only has one adjustment mechanism operatively associated with the end of the vertical or second strut.

Horizontal strut extension 115 is connected to horizontal strut 110 on the opposite end from strut joint 150 and provides an adjustable locking mechanism (pin, detent, thumbscrew, cam lever, etc.) to change the length of this strut and strut extension structure. The embodiment shown utilizes a telescopic tube and holes to pin the extension to the desired length. It should be noted that other means to create an extension include but are not limited to sliding rail, folded sections that are hinged, threaded rod and telescopic tubing utilizing other locking mechanisms. Attached to the end of the horizontal strut extension 115 opposite from the connection point to strut joint 150 is lower tether 120. Lower tether 120 has the same features and construction as upper tether 140.

The following aspects of the construction of a bicycle carrier of the first embodiment are optional and are not needed to realize the main function of this device.

A reduced friction member such as a wheel 130 is attached to the end of carrier trough 105 to allow bicycle carrier 100 to be rolled by lifting the other end of carrier trough 105 and pulling or pushing bicycle carrier 100. It should be noted that other reduced friction members could be utilized to perform this function such as but not limited to different types of wheels or casters, a roller ball, a rounded sphere fixed in place or a skate, slide or skid plate.

Tire stop 160 is firmly attached to carrier trough 105 in such a manner to prevent bicycle 600 from rolling when installed on bicycle carrier 100. This embodiment includes two tire stops 160, one for the front and one for the rear tire of bicycle 600. It should be noted that tire stop 160 is optional. As will be described below, the upper tether 140 and lower tether 120 will hold bicycle 100 in place. However, even with adequate force applied from upper tether 140 and lower tether 120, bicycle 100 may shift slightly during transportation or when bicycle carrier 100 is tipped or held at large angles approaching vertical. Tire stop 160 would minimize movement of bicycle 600 in this situation. Other options to stop or reduce shifting of bicycle 600 relative to the bicycle carrier 100 would include the user placing the tether hook 135 of the upper tether 140 and lower tether 120 in such a location on bicycle 600 such that the back tire of bicycle 600 rests against strut joint 150. Or, the user applies a clamping device on one or both brakes of bicycle 600 while mounted to bicycle carrier 100.

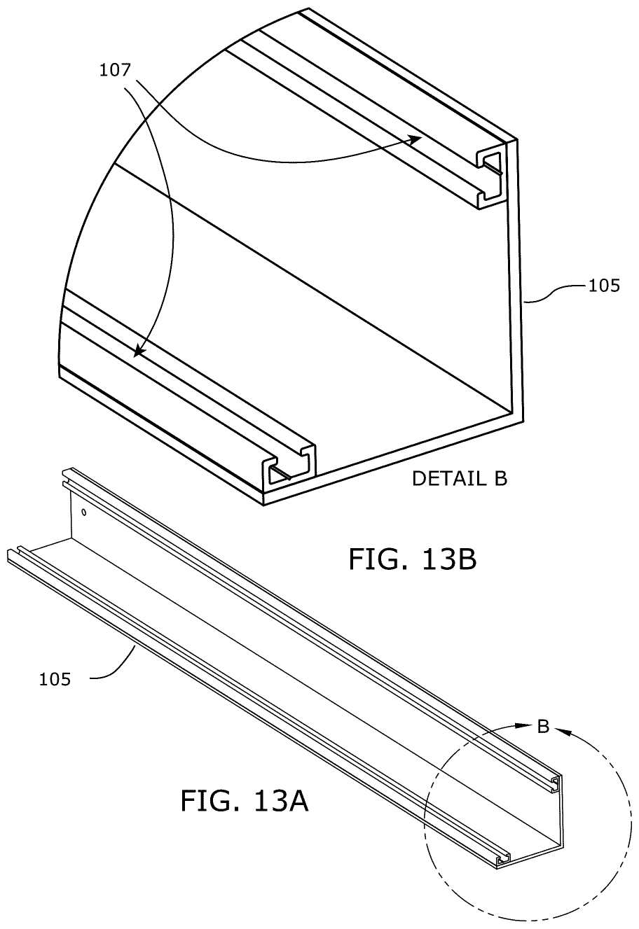

While the carrier trough 105 may be formed as a single piece, such as an elongated or linear aluminum extrusion (see FIG. 13B detailed end view), also contemplated is a trough joint 155 that provides a way for the carrier trough 105 to be assembled from two or more pieces to reduce the overall length of the bicycle carrier apparatus for transportation or storage. In the embodiment depicted in FIG. 1, for example, trough joint 155 is accomplished by a connection plate and fasteners. Other means could be used such as but not limited to a hinged or telescopic joint between the trough pieces.

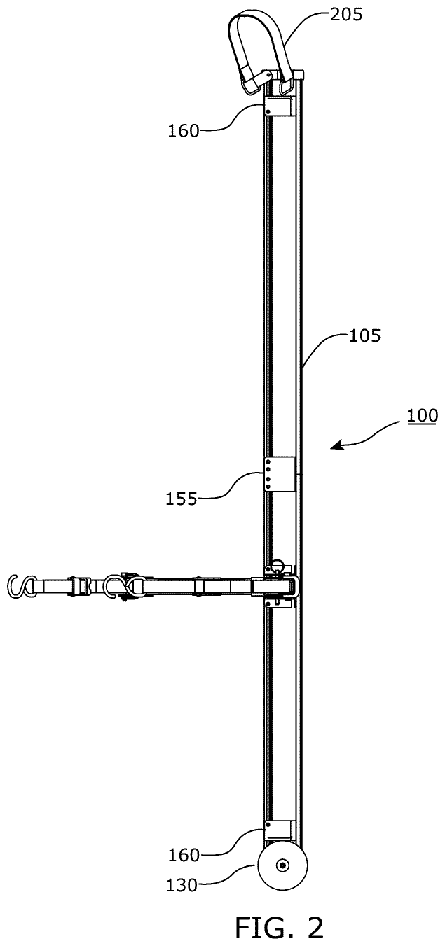

As shown, for example, in FIG. 2, carrier handle 205 provides a means of gripping bicycle carrier 100 for the purpose of moving the device. In the described embodiment carrier handle 205 is constructed of webbing strap affixed to carrier trough 105. Alternatively, a solid handle or solid handle with swivel joint may be attached to the carrier trough 105.

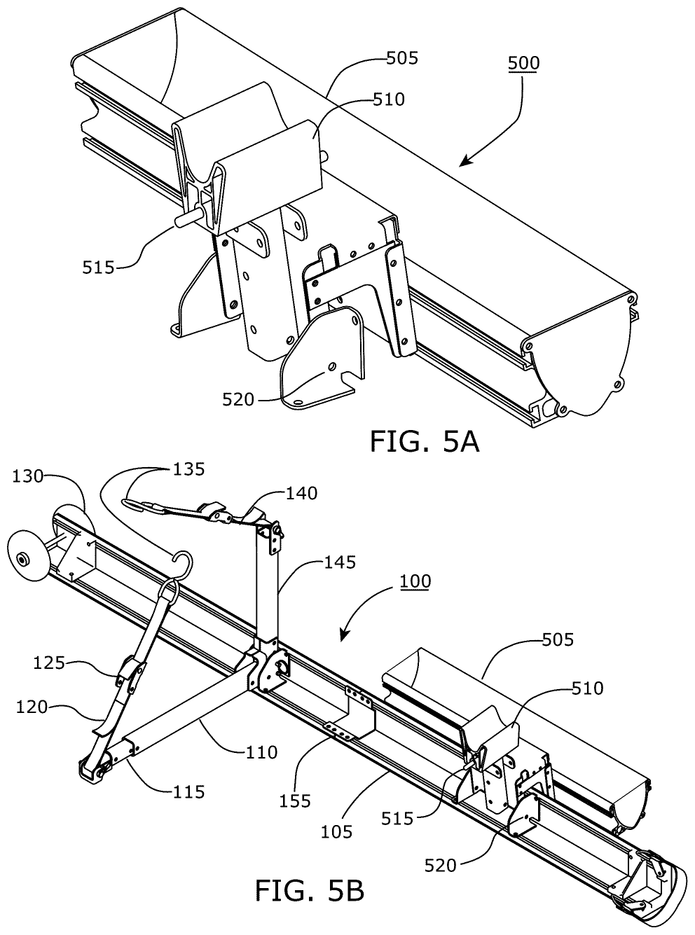

Referring specifically to FIGS. 5A-5B, fork and wheel mount assembly 500 is an optional device that can be removably attached to carrier trough 105 as shown. The purpose of fork and wheel mount assembly 500 is to provide an alternative method to mount bicycle 600 to bicycle carrier 100 with the front tire removed. Fork and wheel mount assembly 500 consists of wheel trough 505 that provide a location to hold the front tire of bicycle 600 when removed. In this embodiment, the removed tire is held by the V-like shape of wheel trough 505, essentially nesting the tire. Other ways to hold the tire include but are not limited to a trough with a tightening strap, clamping mechanism or hook. Bicycle through axle cradle 510 provides a structure to engage the forks of bicycles equipped with either through axle or standard axle configurations. Standard axle configurations are engaged by the fork mount axle 515 feature. Bicycle through axle cradle 510 features a fork and wheel mount pivot 520 that keeps the fork and wheel mount assembly 500 attached to the carrier trough 105 but allows for the assembly to pivot about the longitudinal axis of carrier trough 105 and closely in line with the contact point between the rear tire of bicycle 600 and the bicycle carrier 100. As will be described below, upper tether 140 and lower tether 120 will provide a force to keep bicycle 600 engaged to the fork and wheel mount assembly 500. However, if more stability is desired, locking features could be added to fork and wheel mount assembly 500. Such locking features could include clamping devices or hold down straps.

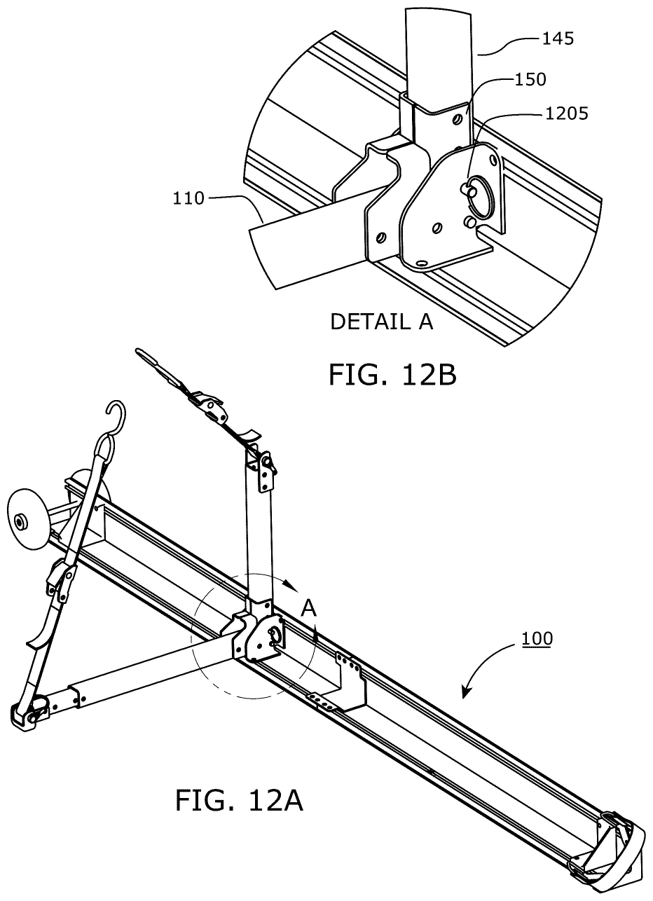

Referring to FIGS. 12A-B, strut joint release pin 545 is provided to allow the quick removal of the L-shaped structure. Holes in the connection point of the struts are aligned such that when strut joint release pin 545 is in place the joint is affixed to the carrier trough 105. When strut joint release pin 545 is removed, the components of the L-shaped structure can be removed for transportation or storage. Other ways to reduce the bicycle carrier size when not in use include a locking hinge mechanism and quick release threaded fasteners.

Attachment points of the strut joint 150, tire stops 160 and fork and wheel mount assembly are adjustable to accommodate various sizes and types of bicycles. Referring to FIGS. 13A-B, in this embodiment, the carrier trough 105 cross-sectional profile features slot channels 107 along the edges of the trough flanges forming the trough 105. Attachment of the various components to the carrier trough 105 is accomplished by means of T-nuts or similar features extending from the components and slidably located in the slot channels 107. In the case of T-nuts, they can be loosened to make adjustments and then retightened. Other ways to allow for the attachment and adjustment of components to the carrier trough 105 include fasteners that clamp to the outside edge of the channel, slots that are of a different shape and/or holes along the trough profile that allow for various connection points.

It should be noted that components attached to the carrier trough 105 could be located in different locations along the length of the carrier trough 105 to facilitate different ways to mount the bicycle 600. For example, the bicycle 600 could be mounted backwards from what is shown in the figures. In this instance, the connection point of the strut joint 150 and other components could be moved to accommodate. Furthermore, the connection point of the strut joint 150 and other components and wheel 130 could be mirrored. In this mirrored configuration, the opposition side of bicycle 600 would be facing the horizontal strut 110 versus the non-mirrored version. It should also be noted that although the description to this point has involved mounting one bicycle to bicycle carrier 100, multiple bicycles could be mounted inline on a single carrier trough 105 with sufficient length, and with the implementation of more L-shaped structures and applicable sub-components (horizontal strut 110, horizontal strut extension 115, vertical strut 145, strut joint 150, lower tether 120, upper tether 140 and tire stops 160, etc.)

Although the description above contains many specifics, these should not be construed as limiting the scope of the embodiments but as merely providing illustrations of some of the several embodiments and alternatives. For example, various other carrier trough designs could be utilized if they provide a nesting feature for the bicycle tires. Furthermore, the carrier trough does not need to be one co-linear piece, it could be in two pieces or even parallel pieces that provide support for the bicycle tires.

### Operation of the Bicycle Carrier

Bicycle carrier apparatus 100 can be operated in two basic modes, one where the front tire of bicycle 600 remains installed and the other where the front tire is removed. The operation where the front tire remains installed will be described first then the mode where the front tire is removed will be discussed second.

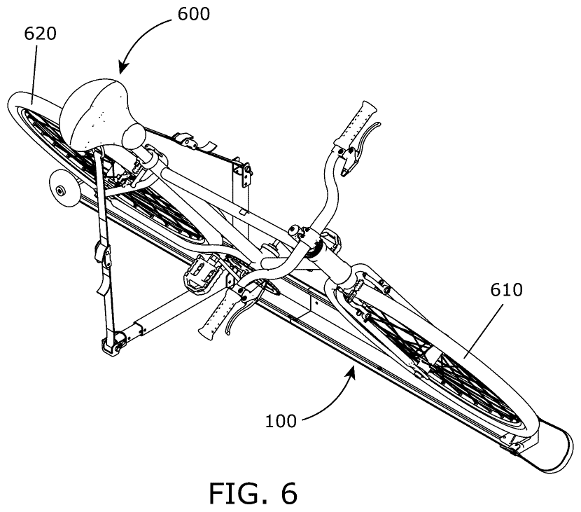

Referring to FIGS. 6 through 9, with the optional fork and wheel mount assembly 500 removed from bicycle carrier 100, and with bicycle carrier 100 on a flat surface, bicycle 600 is placed in carrier trough 105 such that the wheels are inside and parallel with the carrier trough 105, the back bicycle wheel is positioned toward the sliding wheel 130 and bicycle 600 is within the generally L-shaped boundary defined by the vertical strut 145 and horizontal strut 110. If needed the location of the strut joint can be adjusted such that the bicycle 600 is basically located in the center of the bicycle carrier 100. The location of the strut joint 150 will be determined by where the upper tether 140 and lower tether 120 will be connected on the bicycle 600. It should be appreciated that while the strut joint is depicted as maintaining the respective struts 115 and 145 at a right angle, a greater or lesser angle may be used between the struts. Also, if needed, the location of the tire stops 160 can be adjusted to chock the tires of bicycle 600 to prevent any movement along the longitudinal axis of the carrier trough 105.

After any adjustments are made to the location of strut joint 150 and tire stops 160, tether hook 135 of the upper tether 140 is hooked to bicycle 600, generally near the seat. Tether tightener 125 is adjusted as desired to set the angle of bicycle 600 in relation to bicycle carrier 100. At this point bicycle 600 will be leaning at the desired angle held by upper tether 140. The tether hook 135 of the lower tether 120 is hooked to bicycle 600, generally near the location of where upper tether 140 is connected. It is also acceptable for tether hook 135 of the lower tether 120 to be connected to tether hook 135 of the upper tether 140. Tether tightener 125 of the lower tether 120 is adjusted to tighten the tethers and removably attach the bicycle 600 to the bicycle carrier 100. With both the upper tether 140 and lower tether 120 tightened the bicycle 600 will be fixed at an orientation determined by the set length of the upper tether 140 and lower tether 120 and their respective tether angles 117 and 147.

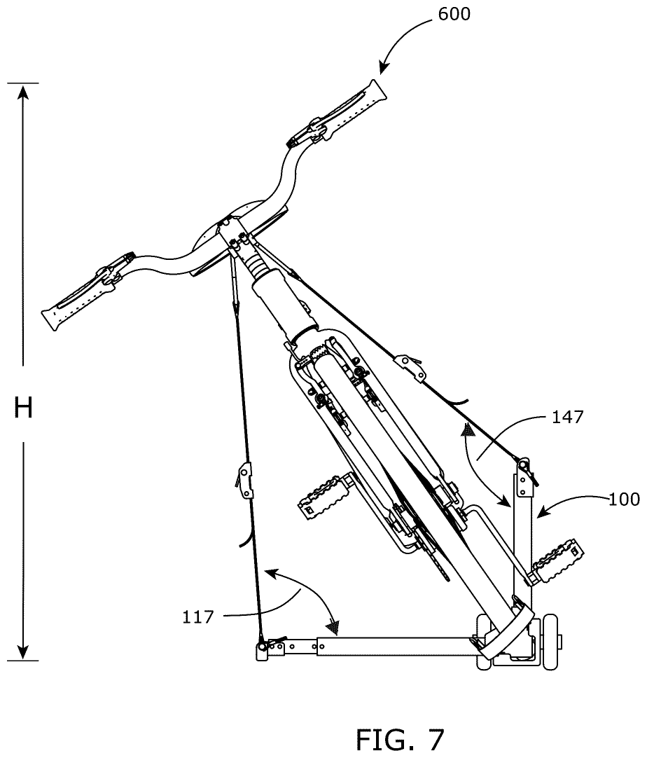

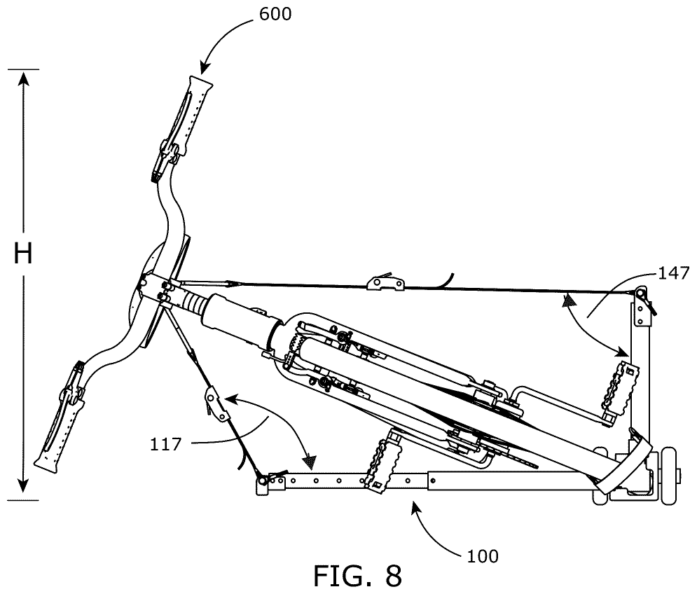

The angle of bicycle 600 can be adjusted to accommodate the needs of the user and the cargo space available in the vehicle. At more horizontal angles such as depicted in FIG. 8, the horizontal strut extension 115 can be adjusted longer to support bicycle 600 in this configuration. At more vertical angles such as depicted in FIG. 7, the horizontal strut extension 115 can be adjusted shorter to take up less width in this configuration.

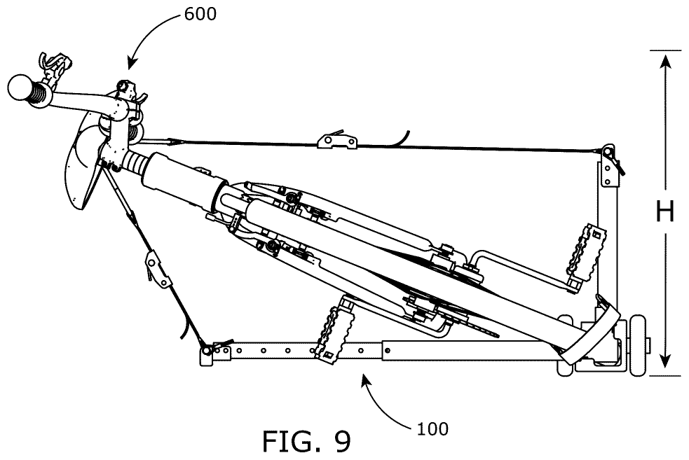

Many bicycles have a way to adjust the angle of the handlebars relative to the forks. Referring to FIG. 9, the handlebars of bicycle 600 are adjusted to be in line with the bicycle body. In this configuration, the overall height (H) of the bicycle carrier arrangement is at its most compact, lending its use in transporting or storing bicycle 600 in small compartments such as the trunk or hatch of a car or other vehicle.

With bicycle 600 securely attached to bicycle carrier 100, the user can lift up bicycle carrier 100 utilizing handle 205 and other features on bicycle 600. At this point the bike carrier 100 can be rolled on wheel 130 as needed since the wheel will now be the only contact to the flat surface of the vehicle cargo area that the end of the bike carrier 100 is resting on. The rolling feature can also come into play when the user uses bike carrier 100 to place a bicycle 600 in a vehicle 1100, aiding in the smooth placement inside the vehicle.

In some circumstances it may be advantageous to transport or store bicycle 600 with the front tire removed. This may come up when the removal of the front tire allows for bicycle 600 to take up less space. For these situations, the optional fork and wheel mount assembly 500 can be utilized. Operation utilizing the fork and wheel mount assembly 500 is very similar to that of when the front tire remains installed and is operated as such.

The fork and wheel mount assembly 500 is first attached on carrier trough 105 at a location between strut joint 150 and carrier handle 205. As in the case when the front tire remains installed, the location of the strut joint 150, fork and wheel mount assembly 500 may need adjusting based on where tether hooks 135 are to be connected to bicycle 600 to locate the bicycle roughly near the middle of carrier trough 105. Once fork and wheel mount assembly 500 is installed and needed adjustments are made, the mounting of bicycle 600 to bike carrier 100 can proceed. It should be noted that in this use case, tire stops 160 will not be needed as the bicycle 600 is locked in place longitudinally by its forks.

The user faces bicycle 600 toward bicycle carrier 100 and places bicycle 600 front tire into wheel trough 505. With the front tire captured by wheel trough 505, the user dismounts the front bicycle tire from bicycle 100 and lifts bicycle 600 away from the front tire. If bicycle 600 is equipped with a through axle, the through axle is reinstalled. Bicycle 600 is then turned around such that it is in line with carrier trough 105 and the back tire is set inside carrier trough 105. The fork of bicycle 600 is then placed on fork and wheel mount assembly 500. If bicycle 600 is equipped with a through axle, the axle is rested in the cradle of bicycle through axle cradle 510. If bicycle 600 is equipped with a quick release axle or bolted axle the fork is rested on the fork mounting axle 515.

At this point the operation is basically the same as described previously, when the front tire of bicycle 600 remains installed. Tether hook 135 of the upper tether 140 is hooked to bicycle 600, generally near the seat. Tether tightener 125 is adjusted as needed to set the angle of bicycle 600 in relation to bicycle carrier 100. At this point bicycle 600 will be leaning at the desired angle held by upper tether 140 and the fork and wheel mount assembly 500 will pivot along with bicycle 600. The tether hook 135 of the lower tether 120 is hooked to bicycle 600, generally near the location of where upper tether 140 is connected. It is also acceptable for tether hook 135 of the lower tether 120 to be connected to tether hook 135 of the upper tether 140. Tether tightener 125 of the lower tether 120 is adjusted to tighten the bicycle 600 relative to the bicycle carrier 100. With both the upper tether 140 and lower tether 120 tightened the bicycle 600 will be fixed at an angle determined by the set lengths of the upper tether 140 and lower tether 120.

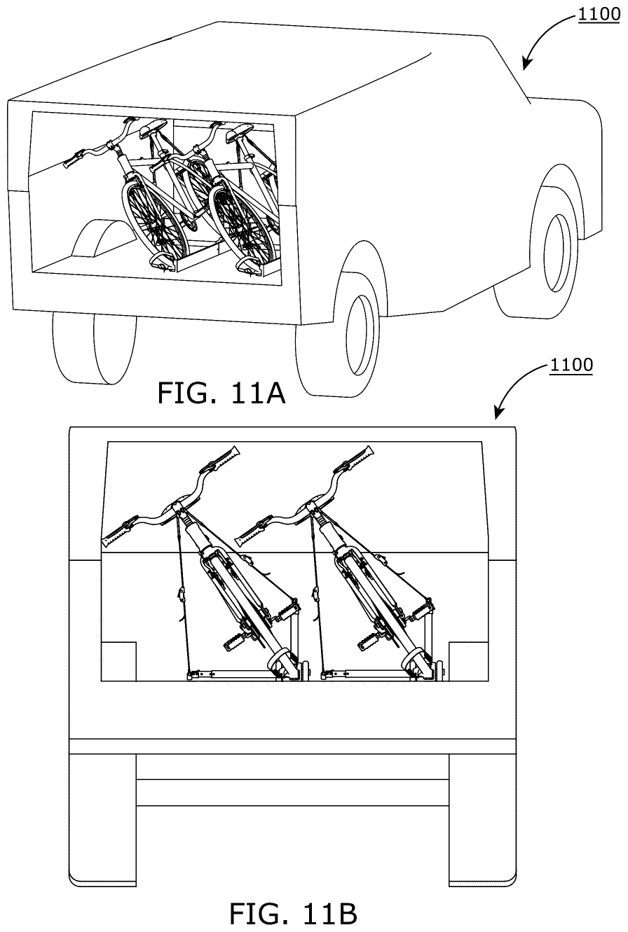

Once bicycle 600 is installed on bicycle carrier 100, bicycle 600 can then be transported in a vehicle or placed in storage in such a manner that best fits the situation. Referring to FIGS. 11A-11B, two bicycle carriers 100 are utilized to transport two bicycles. Bicycle carrier 100 positions the bicycles at the optimum angle for transport in vehicle 1100. Bicycle carrier 100 also provides protection for bicycle 600 by keeping it at an angled position and not resting on more sensitive components like pedals, derailleur or drive train components.

From the description above, the following advantages of the above-described bicycle carrier embodiments become evident:
a) Provides an efficient way for a bicycle to be transported or stored securely by providing a means to tilt the bicycle at an angle that best suits the situation. Positioning the bicycle at near horizontal angles allows for the transportation or storage in areas with limited height while utilizing more width. Positioning the bicycle at near vertical angles allows for the transportation or storage in areas with more height and taking up less width.
b) Compared to using no carrier in the transportation or storage of a bicycle, this device provides protection of the bicycle's components, keeps the bicycle up at an angle that makes room for other equipment or belongings in the same cargo space.
c) Can be utilized for either situation where the front tire of the bicycle needs to be removed for space considerations or for situations where keeping the front tire on is preferred.
d) The operation to attach the bicycle carrier to a bicycle is very streamlined and basically consists of setting the bicycle on the carrier and connecting two tethers and tightening them.
e) In situations that require it, facilitates the removal of the bicycle front tire in preparation for loading a bicycle into a vehicle or storage area by holding the front tire during removal. Furthermore, after the front tire is removed, the tire is retained in its storage position within the envelope of the bicycle maximizing space utilization.
f) Optional features allow for the carrier to be quickly broken down into small elements that are easy to store and transport.
g) Common manufacturing methods and materials can be used, therefore the bicycle carrier can be made for a reasonable cost and excellent performance.

Accordingly, the bicycle carrier apparatus depicted in the various embodiments can be used in many situations that require the transportation of one or more bicycles in the interior cargo area of a vehicle or placed in a storage area. And furthermore, the bicycle carrier also aids in the loading and unloading of a bicycle into the interior of the vehicle, including features such as being able to adjust and set the angle of the bicycle to best utilize space, holding the bicycle front tire within the envelop of the bicycle pedal and frame, maintaining the handlebars in right angle position providing a compact form for storing or transporting the bicycle, and providing means to slide the carrier into a vehicle or storage area. Furthermore, my bicycle carrier can be utilized in situations where the front tire remains on or off. If the front tire needs removal, my device aids in the process of tire removal and storage of the removed tire.

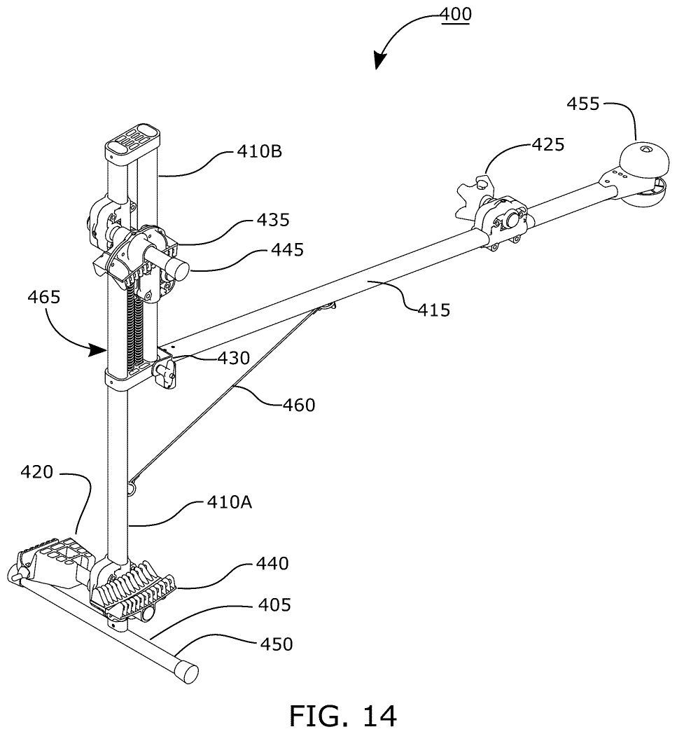

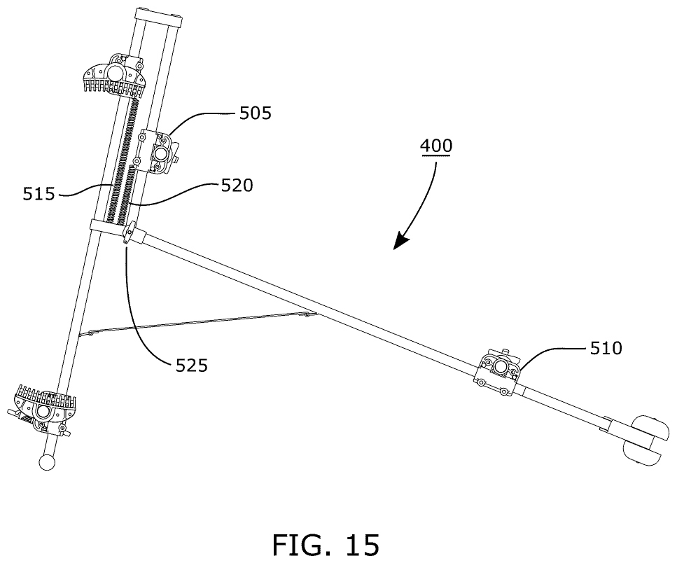

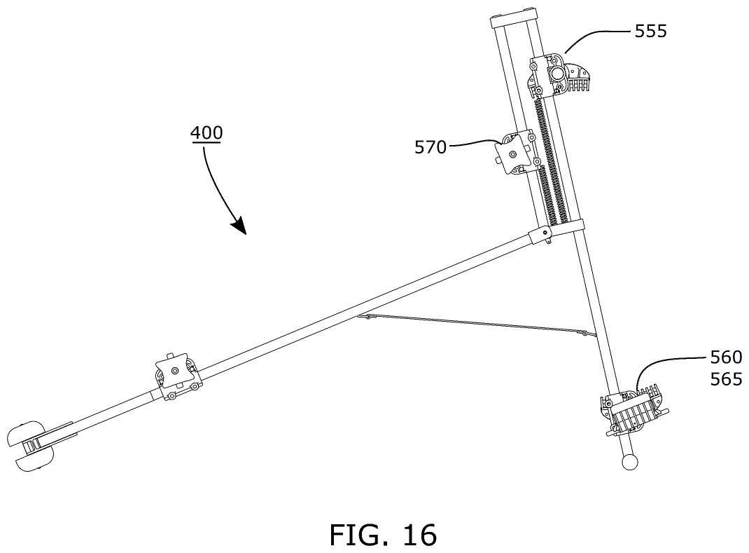

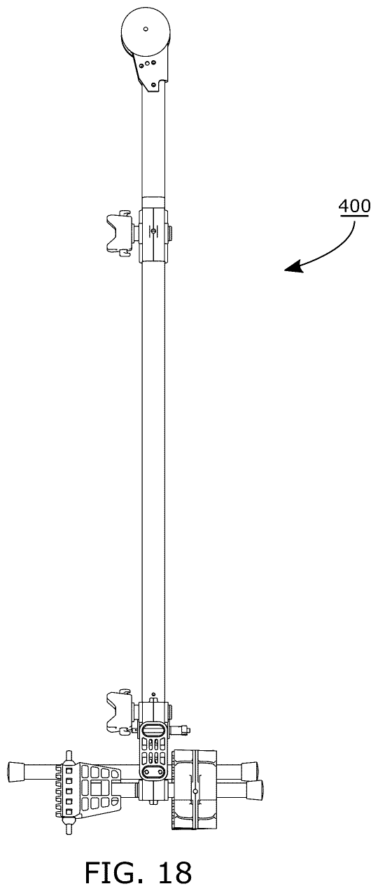

Turning next to an alternative bike carrier/stand embodiments depicted in FIGS. 14-19, the bicycle carrier/stand 400 has three basic use positions. The loading position is used for loading and attaching a bicycle 600 to the bicycle stand 400. The upright position is when a bicycle 600 has been attached to the bicycle stand 400. The third position is the horizontal position in which the bicycle 600 is attached to the bicycle stand 400 and laying on its side with the bicycle stand 400 under the bicycle 600.

The illustrated embodiment of bicycle stand 400 generally includes a rear strut 415 and a forward strut assembly 465, which in turn is comprised of a forward strut track side 1, 410A, and forward strut track side 2, 410B. The forward strut track side 1, 410A, and forward strut track side 2, 410B, allow for the slidable traverse of components along the forward strut assembly 465 independently as will be described later in this description. In addition, the use of the term “track” refers to an element that allows attached components to slide or move transversally along its length but also prevents rotation of traversing components about a longitudinal axis of the track. In the following description, the term “strut” is used to describe the structural member that may include features to perform the track function or could be the member that supports other elements that perform the track function. For example, one or more of the disclosed struts may have a generally circular cross-section and further include one or more longitudinal channels or grooves to which slidably attached components align to prevent rotation of the component as it is slid along the strut. Alternatively, one or more of the disclosed struts may be formed with a non-circular cross-section (e.g., square or hexagonal tubing) and an attached component(s) may have a matching interior profile to prevent rotation around the strut.

Rear strut 415 is connected to forward strut assembly 465 via a strut hinge 430. Strut hinge 430 allows the rear strut 415 to rotate in-line with the forward strut assembly 465. Hinge stop 460 limits the angle between the rear strut 415 and the forward strut assembly 465 to approximately 90-degrees to provide support to maintain the forward strut assembly 465 upright in the loading position. In this embodiment hinge stop 460 is constructed of a cable fastened to the rear strut 415 and forward strut assembly 460 as shown in FIG. 14. However, other means to maintain the forward strut assembly 465 upright in the loading position could be accomplished as a feature of strut hinge 430 such as detented stops or other interfering components on the hinge that limit the strut hinge's rotation. In the embodiment illustrated, strut hinge 430 features a quick release pin 525 that is removable to allow the rear strut 415 to be disconnected from the front strut assembly 465, to facilitate disassembly and storage or transportation of the bicycle stand 400.

Frame foot 405 is connected to the lower section of forward strut assembly 465 to provide a base to maintain the forward strut assembly 465 upright in the bicycle loading position in conjunction with rear strut 415, and the upright position in conjunction with an attached bicycle 600. In the illustrated embodiment frame foot 405 is a linear strut that is perpendicular to the forward strut assembly 465 and rear strut 415.

Bicycle fork adapter 420 is constructed such that it can capture bicycle 600 forks by means such as an incorporated shaft to engage the bicycle 600 fork wheel mounts as in the case of bolted axle or quick release style bicycle forks, or appropriately sized thru axle shaft retainer. The embodiment of bicycle fork adapter 420 shown in FIG. 14 is configured of a combined use fixture or nest that has a shaft to capture bolted axle or quick release style bicycle forks and a trough to capture thru axle forks where the bicycle fork has the thru axle installed but not the bicycle wheel. Bicycle fork adapter to strut connector 565 connects the bicycle fork adapter 420 to the forward strut assembly 465, specifically the forward strut track side 1, 410A, in such a fashion as to position bicycle fork axle mounts approximately parallel with rear strut 415 and above the frame foot 405 and in such a fashion to position the bicycle 600 head tube approximately parallel with the forward strut assembly 465. Bicycle fork adapter to strut connector 565 is attached to the forward strut assembly 465 in such a fashion that its position along the forward strut track side 1, 410A, can be adjusted. In one embodiment of bicycle stand 400 bicycle fork adapter to strut connector 565 is fixed to a position nearly to the bottom of forward strut assembly 465. In addition, bicycle fork adapter 420 and bicycle fork adapter to strut connector 565 allow the rotation of the bicycle fork adapter 420 around the axis perpendicular to forward strut assembly 465 and rear strut 415. This rotational degree of freedom (DOF) will accommodate various bicycle fork pitches.

Forward bicycle attachment connector 570 is constructed as such to provide a means to attach to a bicycle 600 component such as part of the bicycle 600 frame, handlebars or other structurally sound component. In one embodiment, forward bicycle attachment connector 570 is constructed of a rubber like saddle that incorporates an elastic or rubber tie-down that captures the bicycle frame or more desirable the handlebar stem 1220 of bicycle 600 just above the headset 1224 of bicycle 600. Other suitable alternatives to the saddle design of connector 570 include but are not limited to clamps, ratcheting hold-downs and magnetic clamps. Forward bicycle attachment connector 570 is attached to the forward strut assembly 465, specifically the forward strut track side 2, 410B, by means of the forward bicycle attachment connector to strut connector 505. The forward bicycle attachment connector to strut connector 505 positions the forward bicycle attachment connector 570 perpendicular to the forward strut assembly 465 and rear strut 415 and on the same side as the bicycle fork adapter 420. The forward bicycle attachment connector 570 is mounted near as possible to the forward strut assembly 465 to minimize the distance between the attached bicycle 600 but still allow for room to facilitate the operation of connecting the forward bicycle attachment connector 570 to the bicycle 600. The forward bicycle attachment connector to strut connector 505 allows the rotation of the forward bicycle attachment connector 570 around the axis perpendicular to forward strut assembly 465 and rear strut 415. This rotational degree of freedom (DOF) will accommodate various bicycle handlebar and frame designs. Forward bicycle attachment connector to strut connector 505 incorporates a means to slidably traverse along the forward strut assembly 465 to accommodate connecting the forward bicycle attachment connector 570 at a suitable point on the bicycle 600 when the bicycle 600 is mounted in the bicycle fork adapter 420. In the illustrated embodiment, bicycle forward hold-down 520 provides a tensile force on the bicycle attachment connector to strut connector 505 toward the bicycle fork adapter 420 which provides a means to capture the bicycle into the bicycle fork adapter 420. Bicycle forward hold-down 520 can be realized by means of, but not limited to, a metal spring, elastic cord, or rubber strap. Alternatively, other embodiments could use other means to hold the bicycle attachment connector to strut connector 505 in place after it has been positioned as needed such as, but not limited to, the use of a locking clamp or detents along the forward strut assembly 465.

Lower tire attachment connector 440 is constructed to capture a bicycle tire and rim. In the illustrated embodiment, the lower tire attachment connector 440 is designed as a curved saddle that is intended to grip a bicycle tire at its circumference, and features a swivel pivot to position the curved saddle of the connector fully on the bicycle tire. Other embodiments could utilize other tire attachment means such as but not limited to U shaped brackets, rubber straps, clamps or ratcheting hold-downs. Lower tire attachment connector 440 is attached to the forward strut assembly 465, specifically the forward strut track side 1, 410A, by means of the lower tire attachment connector to strut connector 560. The lower tire attachment connector to strut connector 560 positions the lower tire attachment connector 440 perpendicular to the forward strut assembly 465 and the rear strut 415 and on the opposite side of bicycle stand 400 from the bicycle fork adapter 420. The lower tire attachment connector to strut connector 560 positions the lower tire attachment connector 440 far enough away from the forward strut assembly to accommodate the width of a bicycle tire, but close enough to keep a bicycle tire from extending beyond the surface plane when the bicycle stand 400 is in the horizontal position. In one embodiment, the lower tire attachment connector to strut connector 560 and the bicycle fork adapter to strut connector are constructed as one unit and fixed at a point nearly to the lower end of the forward strut assembly 465. In other embodiments, the lower tire attachment connector to strut connector 560 could be separate assemblies.

Like the lower tire attachment connector, upper tire attachment connector 435 is constructed as such to capture a bicycle tire and rim. In the illustrated embodiment, the upper tire attachment connector 435 is realized as a curved saddle that is intended to grip a bicycle tire at its circumference and features a swivel pivot to position the saddle fully on the bicycle tire. Other embodiments could utilize other tire attachment means such as but not limited to U-shaped brackets, rubber straps, clamps or ratcheting hold-downs. Upper tire attachment connector 435 is attached to the forward strut assembly 465, specifically the forward strut track side 1, 410A, by means of the upper tire attachment connector to strut connector 555. The upper tire attachment connector to strut connector 555 positions the upper tire attachment connector 435 perpendicular to the forward strut assembly 465 and the rear strut 415 and on the opposite side of bicycle stand 400 as the bicycle fork adapter 420. The upper tire attachment connector to strut connector 555 positions the upper tire attachment connector 435 far enough away from the forward strut assembly to accommodate the width of a bicycle tire, but close enough to keep a bicycle tire from extending beyond the surface plane when the bicycle stand 400 is in the horizontal position. In the illustrated embodiment, the upper tire attachment connector to strut connector 555 traverses along the forward strut assembly 465 to accommodate various bicycle tire diameters. Wheel hold-down 515 provides a tensile force on the upper tire attachment connector to strut connector 555 toward the lower tire attachment connector 440 and along the forward strut assembly 465. This force is suitable to retain a bicycle tire when captured between the lower tire attachment connector 440 and the upper tire attachment connector 435. Wheel hold-down 515 can be realized by means of but not limited to a metal spring, elastic cord, or rubber strap. Alternatively, other embodiments could use other means to hold the upper tire attachment connector to strut connector 555 in place after it has been positioned as needed such as but not limited to the use of a locking clamp or detents along the forward strut assembly 465.

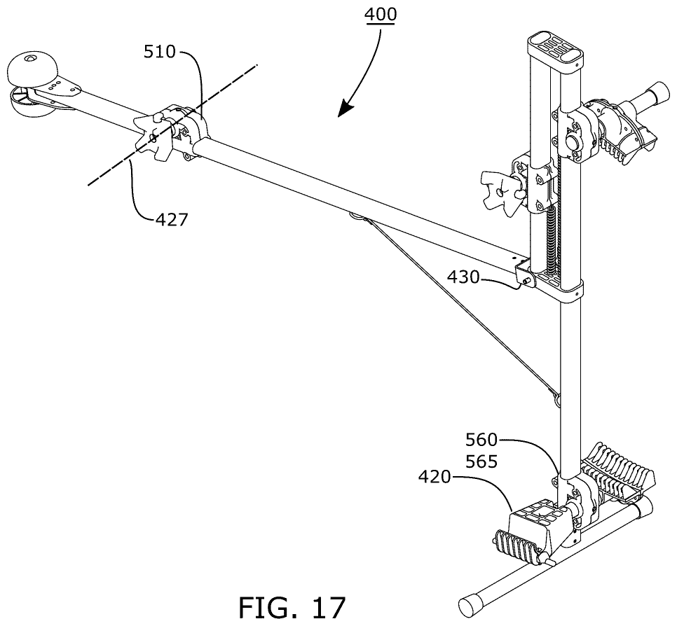

Rear bicycle attachment connector 425 is constructed as such to provide a means to attach to a bicycle 600 component such as part of the bicycle 600 frame, or other structural component. In the illustrated embodiment, rear bicycle attachment connector 425 is constructed of a rubber like saddle that incorporates an elastic or rubber tie-down to capture the bicycle 600 frame. Other suitable alternatives to the saddle design include but are not limited to clamps, ratcheting hold-downs and magnetic clamps. Rear bicycle attachment connector 425 is attached to the rear strut 415 by means of the rear bicycle attachment connector to strut connector 510. The rear bicycle attachment connector to strut connector 510 positions the rear bicycle attachment connector 425 perpendicular to the forward strut assembly 465 and rear strut 415 and on the same side of the bicycle stand 400 as the bicycle fork adapter 420. The rear bicycle attachment connector 425 is mounted as near as possible to the rear strut 415 to minimize the distance between the attached bicycle 600 but still allow for room to facilitate operation of connecting the rear bicycle attachment connector 425 to the bicycle 600. The rear bicycle attachment connector to strut connector 510 allows the rotation of the rear bicycle attachment connector 425 around an axis 427 (see FIG. 17) perpendicular to forward strut assembly 465 and rear strut 415. This rotational degree of freedom (DOF) will allow for the accommodation of various bicycle frame designs. Rear bicycle attachment connector to strut connector 510 incorporates a means to traverse along the rear strut 415 to accommodate the ability to connect the rear bicycle attachment connector 425 at a suitable point on the bicycle 600 when the bicycle 600 is mounted in the bicycle fork adapter 420. In the illustrated embodiment, rear bicycle attachment connector to strut connector 510 is locked in place along the rear strut 415 when attached to a bicycle 600 during use. In other embodiments, an additional locking mechanism such as but not limited to a clamp or detents along the rear strut 415 could be incorporated to further lock the rear bicycle attachment connector to strut connector 510 to the rear strut 415 during use.

In order to maintain the position of the bicycle stand 400 when in the horizontal position, three stand-offs are incorporated in the bicycle stand 400, the upper frame side leg 445, lower frame side leg 450 and the rear strut side rest 455. The upper frame side rest 445 and the lower frame side rest 450 are mounted on the forward strut assembly in such a manner to provide stand-offs that are far enough apart to provide stability and long enough to keep a bicycle 600 from contacting the horizontal surface 1210 when the bicycle stand 400 in is the horizontal position. In the illustrated embodiment, the lower frame side leg 450 is an extension of the frame foot 405. The upper frame side 445 is incorporated with the upper tire attachment connector to strut connector 555. In other embodiments, the upper frame side rest 445 and the lower frame side rest 450 could be incorporated with other features on the front strut assembly 465 or as separate entities. In the illustrated embodiment, upper frame side leg 445 and lower frame side leg 450 are at a fixed height. In other embodiments, the upper frame side leg 445 and lower frame side leg 450 could have an adjustable height feature, accomplished by such means but not limited to cams, telescoping tubes, threaded screws and detented stops.

The rear strut side rest 455 is mounted to the rear strut 415 towards the end of the rear strut 415 away from the forward strut assembly 465. In one embodiment the rear strut side rest 455 incorporates at least one reduced-friction member such as a roller, wheel, skate or slide that allows the end of bicycle stand 400 to be easily moved across a surface smoothly when in the horizontal position and lifted such as to rest on just the rear strut side rest 455 like how a wheel barrel rolls on a front wheel. The rear strut side rest 455 is depicted as including a pair of wheels or rollers, one on either side and pivotally attached to the end of the rear strut 415 to facilitate rolling. In one embodiment, the frame side rest 455 features a height adjustment to accommodate different size bicycles and horizontal surfaces. In other embodiments, the rear strut side rest 455 could be but not limited to a fixed leg, an adjustable leg, a slide, or a fixed wheel.

Some descriptions included in the description above included alternative embodiments. The following description further expands on additional embodiments.

As described in the illustrated embodiment, the forward strut assembly 465 is comprised of a forward strut track side 1, 410A, and forward strut track side 2, 410B. In another embodiment, the forward strut assembly 465 could consist of one track and have the order of positions of attached components such as the upper tire attachment connector 435, lower tire attachment connector 440, forward bicycle attachment connector 570 and bicycle fork adapter 420 fixed. This would limit the adaptability of connecting to various types of bicycles since there would be additional constraint on the available positions of each component. For example, if the upper tire attachment connector 435 were located above the forward bicycle attachment connector 570, then that embodiment would not work for any situation that required the opposite. However, a single-track design could have the advantage of lower construction cost since there is one track instead of two. Furthermore, in the illustrated embodiment, the separate tracks are realized by the use of two separate strut profiles where the upper tire attachment connector to strut connector 555 and forward bicycle attachment connector to strut connector 505 encompass the exterior of the track, this same function could be realized by having one or more tracks along the profile of the forward strut assembly 465 that utilized internal tracks such as T-slots or other suitable tracks.

As an alternative to having the lower tire attachment connector 440 having a fixed position along the forward strut assembly 465 and the upper tire attachment connector 435 having a movable position along the forward strut assembly 465, both lower tire attachment connector 440 and upper tire attachment connector 435 could have adjustable positions along the forward strut assembly 465 and locked into position as needed to secure a bicycle tire.

In the illustrated embodiment, strut hinge 430 is located at a fixed position along the forward strut assembly 465 approximately mid-way along its length. In another embodiment, strut hinge 430 could be movable along the length of the forward strut assembly 465 and locked into place when needed for the loading position. Furthermore, alternative to utilizing a quick release pin 525, the strut hinge 430 could utilize a fixed pivot pin that is not removed during use.

### Operation of the Bicycle Stand

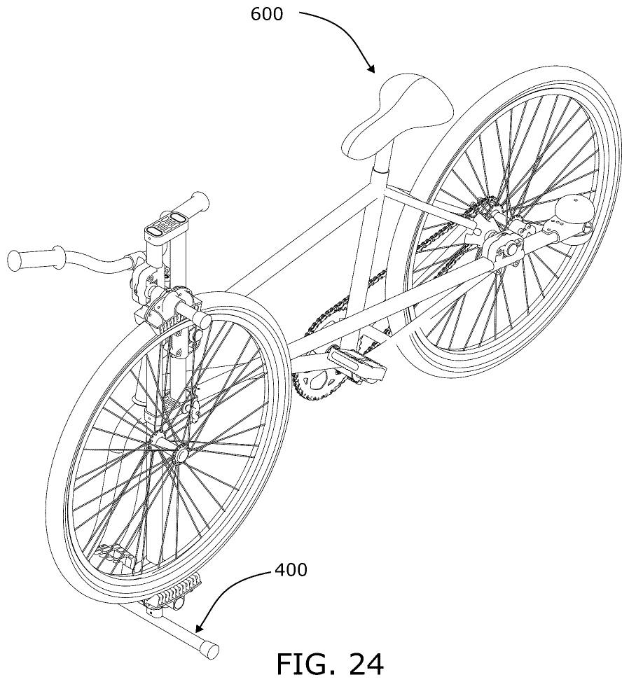

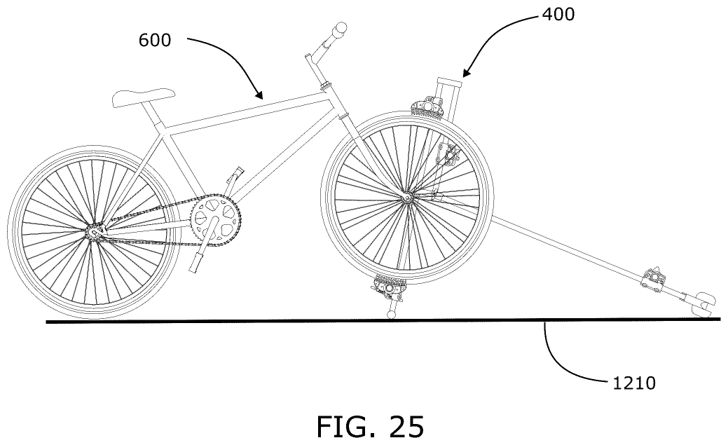

Generally, the first operation for attaching a bicycle 600 to stand 400 is to remove the front tire of the bicycle, which is accomplished by placing the bicycle stand 400 in the loading position as shown in FIG. 25. The upper tire attachment connector 435 and lower tire attachment connector 440 are separated enough to allow the front tire of the bicycle 600 to be placed in-between and locked into place as shown in FIG. 24. The bicycle stand 400 will hold the bicycle 600 upright and allow the user to loosen the front tire axle and lift the bicycle 600 away from the bicycle front tire. For bicycles equipped with thru axle front wheels, the user would replace the thru axle back into the fork of the bicycle 600.

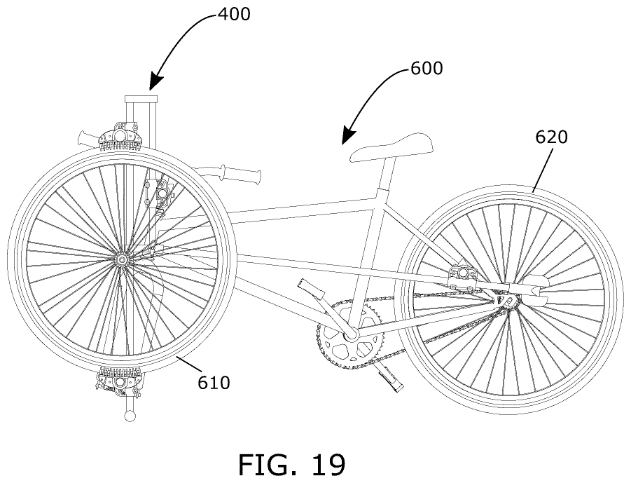

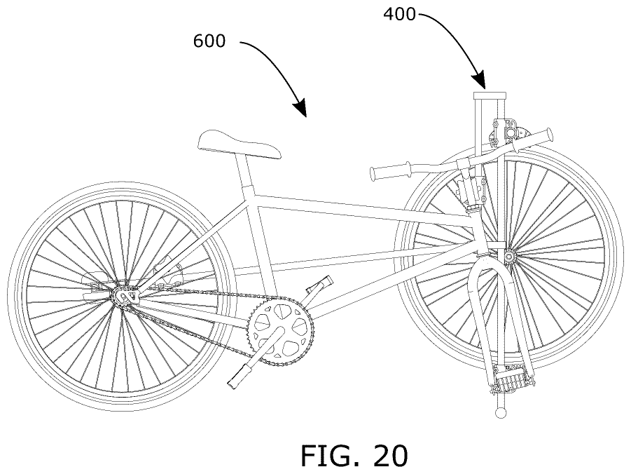

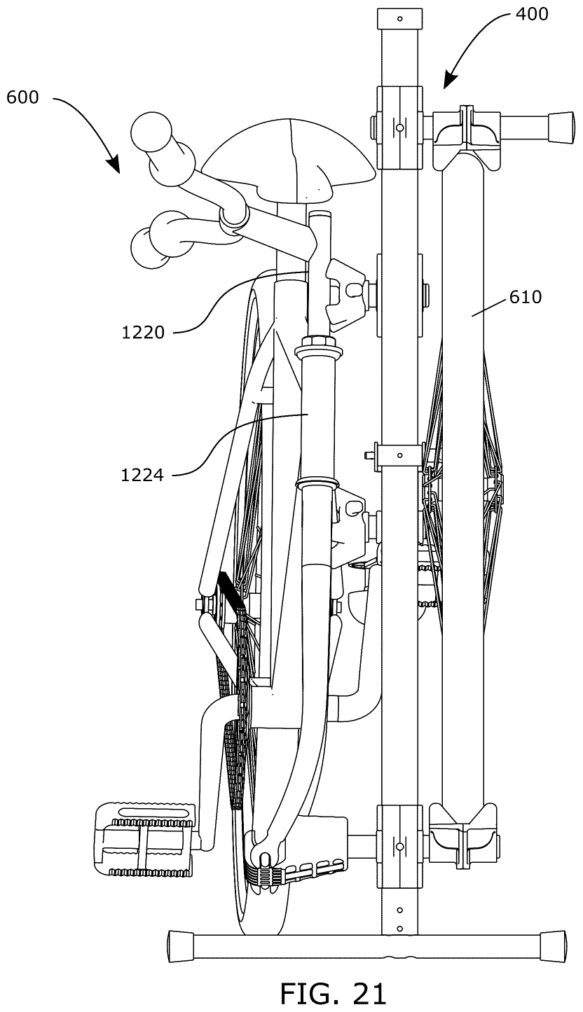

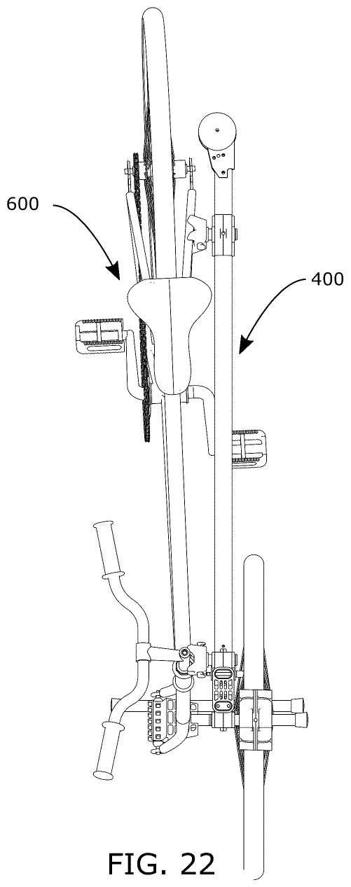

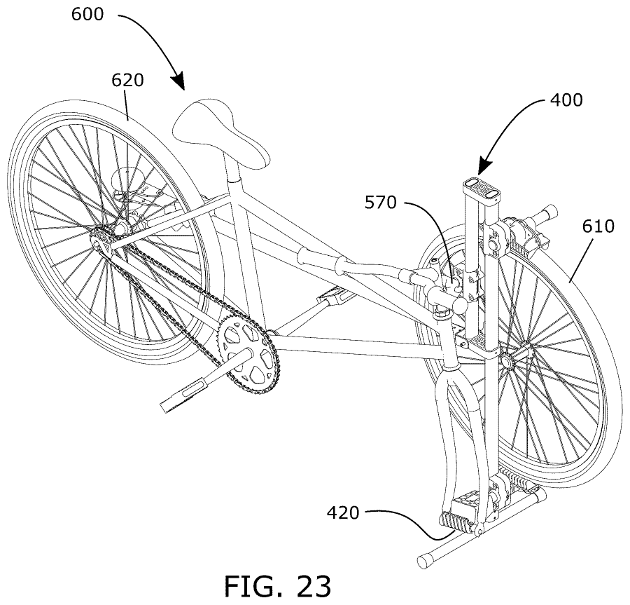

Referring to FIG. 23, the user then repositions the bicycle 600 such that the bicycle fork is aligned with the capture features of the bicycle fork adapter 420. The forward bicycle attachment connector 570 is attached to the bicycle 600 near or on the bicycle 600 handlebar stem. At this point, the bicycle forward hold-down 520 will apply a holding force on the bicycle 600 frame to hold the bicycle 600 in place allowing the bicycle 600 to stand on its own. The user then positions the rear strut 415 and rear bicycle attachment connector 425 relative to a position on the bicycle 600 frame near the bicycle 600 rear tire axle and attaches the rear bicycle attachment connector 425 to the bicycle 600. At this point, the bicycle 600 is fully attached to the bicycle stand 400. The bicycle stand 400 fully attached to the bicycle 600 is shown in FIGS. 19 through 24.

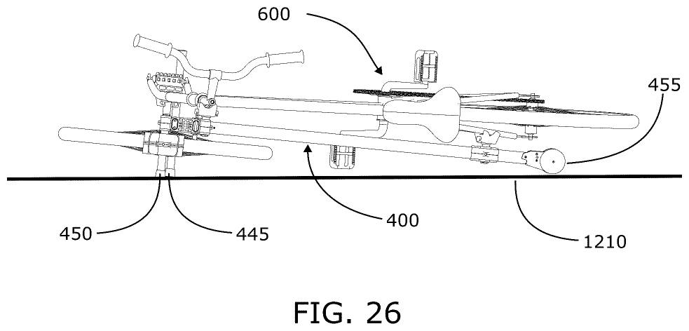

Referring to FIG. 26, when the bicycle stand 400 is in the horizontal position with the bicycle 600 attached, the bicycle 600 is now able to be placed horizontally resting on upper frame side leg 445, lower frame side leg 450 and rear strut side rest 455 above the horizontal surface 1210. No component of bicycle 600 is in contact with horizontal surface 1210.

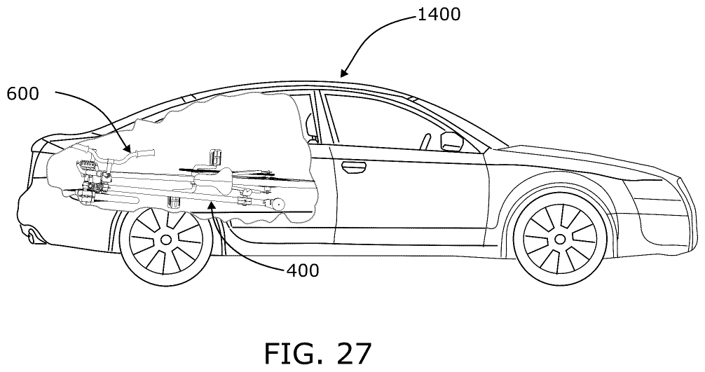

At this point, the user can use this configuration to load the bicycle 600 with the aid of the bicycle stand 400 into various vehicle configurations such as the trunk or cargo area of a car, back of a van or bed of a pickup truck. FIG. 27 shows a cutout view of a typical sedan with fold down back seats with the bicycle stand 400 and bicycle 600 inside of the vehicle. To load the bicycle 600 with the bicycle stand 400 into a vehicle, the user would lift the bicycle stand 400 and position it horizontally and load it into the vehicle leading with the rear strut side rest 455 down. The wheel(s) on the rear strut side rest 455 allows the bicycle stand 400 to be rolled into the vehicle along the bottom interior surface of the vehicle. Once the bicycle stand 400 is fully in the vehicle, the user then lowers the end opposite of the rear strut side rest 455 onto the lower frame side leg 450 and upper frame side leg 445. At this point the bicycle 600 is fully in the vehicle and the supported by the bicycle stand 400 as shown in FIG. 27.

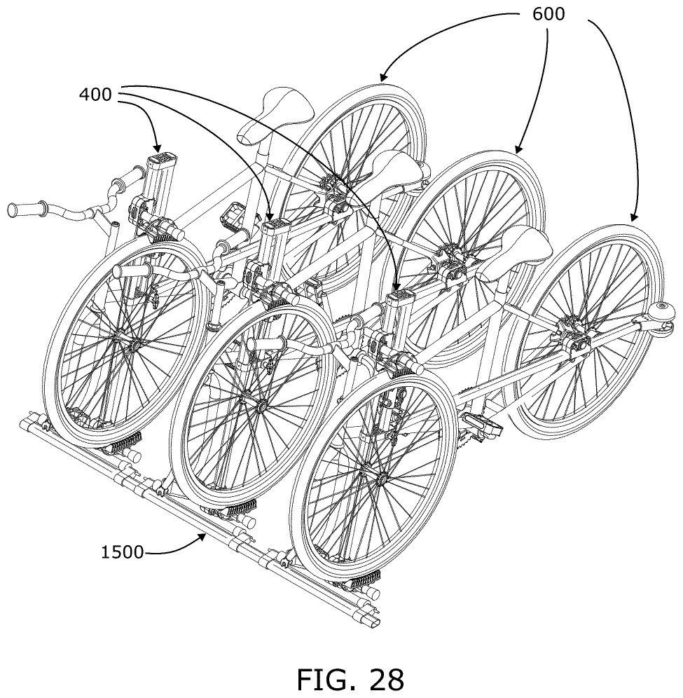

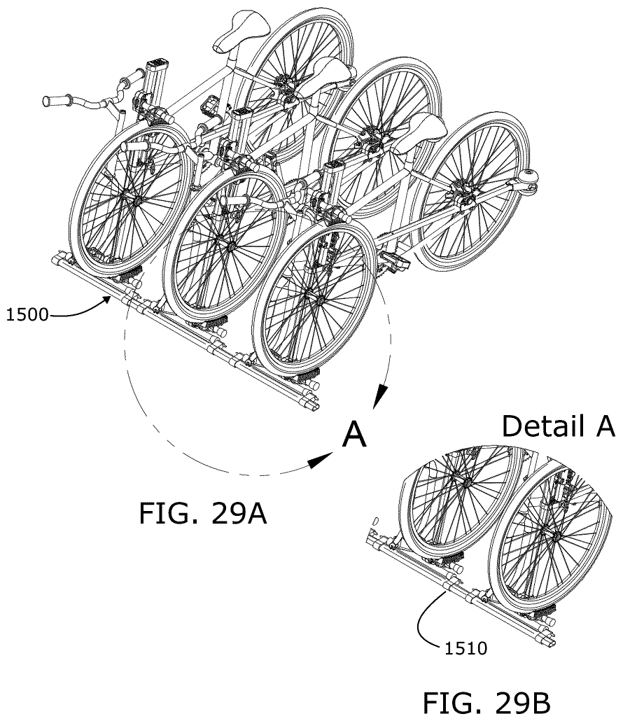

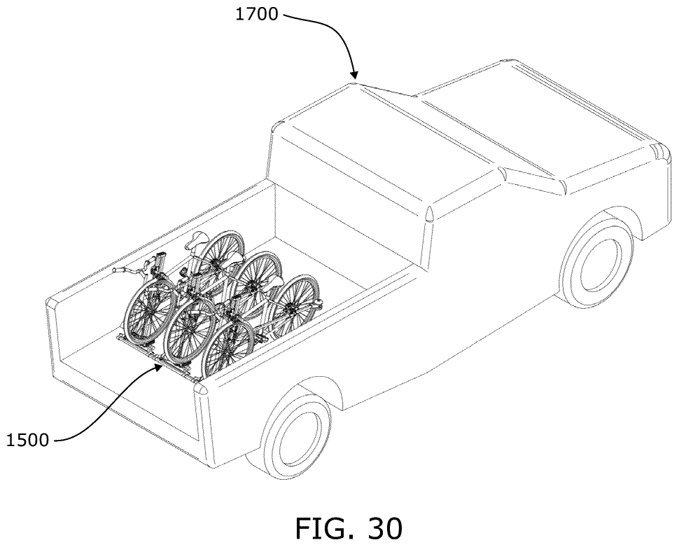

Bicycle stand 400 can also be used to transport bikes in the upright position by resting the frame foot 405 on the vehicle, such to the floor of a pickup truck or van. In this use case, it should be noted that this situation would lend itself to transporting multiple bicycles. FIG. 28 shows multiple bicycles attached to a multi-mount strut 1500 assembly that could be placed in the vehicle to secure multiple bicycles. FIGS. 29A-29B show more details of one embodiment of connecting the bicycle stand 400 to a multi-mount strut 1500 by use of a multi-mount strut connector 1510 that connects frame foot 405 of each bicycle stand 400 to the multi-mount strut 1500. FIG. 30 shows an example of multiple bicycles loaded in the bed of vehicle such as a pickup truck 1700. As an alternative to multi-mount strut 1500, each bicycle stand 400 could “attach” to an adjacent stand using a coupler that receives one end of the lower frame side leg 450 of each stand.

From the description above, a number of advantages of some of the bicycle carrier/stand embodiments become evident:
(a) Provides a way for a bicycle to be set upon its side and protected in many situations such as in the trunk of a car, storage shelf, under a bed, bed of a pickup truck or back of a van elevated to protect components of the bicycle.
(b) Operation to attach the bicycle stand to a bicycle is very streamlined and basically consists of a few simple steps: tire removal, securing the bicycle onto the fork adapter, securing the forward bicycle attachment connector and securing the rear bicycle attachment connector.
(c) Facilitates the removal of the bicycle front tire in preparation for loading a bicycle into a vehicle by holding the front and bicycle during removal. Furthermore, after the front tire is removed, the tire is in its storage position reducing the number of steps the user needs to take.
(d) Can be used to position the bicycle in a vertical or horizontal position without having to reattach the device.
(e) Facilitates the transportation of multiple bicycles by resting or attaching the frame foot of each bicycle stand to a simple strut or feature of the vehicle such as the bed of a pickup truck or floor of a van.
(f) Common manufacturing methods and materials can be used, therefore can be made for a similar cost to prior art but with better performance.

Accordingly, the bicycle carrier of apparatus depicted in the various embodiments can be used in many situations that require the transportation of one or more bicycles in the interior cargo area of a vehicle or placed in a storage area. And furthermore, the bicycle carrier also aids in the loading and unloading of a bicycle into the interior of the vehicle, including features such as being able to adjust and set the angle of the bicycle to best utilize space, holding the bicycle front tire within the envelop of the bicycle pedal and frame, maintaining the handlebars in right angle position providing a compact form for storing or transporting the bicycle, and providing means to slide the carrier into a vehicle or storage area. Furthermore, my bicycle carrier can be utilized in situations where the front tire remains on or off. If the front tire needs removal, my device aids in the process of tire removal and storage of the removed tire.

Although the description above contains many specificities, these should not be construed as limiting the scope of the embodiments but as merely providing illustrations of some of the several embodiments. For example, the struts in the illustrated embodiment are straight, these could be curved or other linear shape as to position the connection points as needed. The struts in the illustrated embodiment are of fixed length, these could have adjustable length such as the use of telescoping tubing.

Thus the scope of the embodiments should not be limited by the examples given. It should be further understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A bicycle carrier apparatus for securely storing a bicycle within a vehicle or storage space, comprising:
(a) a carrier trough having a profile shaped to engage the tires of the bicycle;
(b) a first strut and a second strut connected by a strut joint, the strut joint further adjustably attaching the first strut and the second strut to the carrier trough, wherein the length of said second strut is sufficient to provide an adequate tether angle without adversely affecting the overall height of the bicycle carrier apparatus; and
(c) an upper tether and a lower tether, respectively attached to said second strut and said first strut, each tether equipped with a tether hook and a tether tightener to secure the bicycle in contact with said carrier trough.

2. The bicycle carrier apparatus of claim 1, wherein the first strut includes a first strut extension connected to said first strut, said extension being adjustable relative to the first strut and having sufficient length to provide support to balance the bicycle carrier apparatus on the carrier trough, first strut and first strut extension.

3. The bicycle carrier apparatus of claim 1, wherein said carrier trough is configured with at least one reduced-friction member attached to said carrier trough to allow the bicycle carrier to be moved while resting upon the reduced friction member.

4. The bicycle carrier apparatus of claim 1, wherein said carrier trough is configured with one or more tire stops operatively associated with said carrier trough to prevent the bicycle from moving longitudinally along said carrier trough.

5. The bicycle carrier apparatus of claim 1, wherein said carrier trough includes a pair of trough pieces connected by a trough joint.

6. The bicycle carrier apparatus of claim 1, further comprising a fork and wheel mount assembly attached to said carrier trough, said fork and wheel mount assembly comprising:
(a) a wheel trough for holding a removed front bicycle tire;
(b) a bicycle through axle cradle for securing a bicycle fork when the front tire is removed;
(c) a fork mounting axle to secure a bicycle fork having a standard axle configuration; and
(d) a pivot point allowing said fork and wheel mount assembly to rotate in line with a rear tire contact point on said carrier trough, enabling angular adjustment of the bicycle and fork and wheel mount assembly relative to the carrier trough.

7. The bicycle carrier apparatus of claim 2, wherein said first strut extension telescopes relative to the first strut and includes an adjustable locking mechanism for releasably adjusting the length of the combined first strut and first strut extension.

8. The bicycle carrier apparatus of claim 1, wherein the strut joint is detachable and foldable for easy disassembly and compact storage.

9. The bicycle carrier apparatus of claim 1, wherein said upper and lower tethers are each is constructed of a flexible webbing material and can be adjusted using a tether tightener.

10. The bicycle carrier apparatus of claim 1, further comprising a handle affixed to said carrier trough.

11. The bicycle carrier apparatus of claim 1, wherein said carrier trough features adjustable attachment points along its length,

12. The bicycle carrier apparatus of claim 11 wherein said attachment points comprise slots to allow for sliding and securing of components at various positions.

13. The bicycle carrier apparatus of claim 1, wherein said carrier trough profile is selected from the group consisting of: an L-shaped angle stock, a rounded bottom trough, a V-shaped trough, or other concave geometry providing central tire alignment and facilitating angular adjustment of the bicycle within said carrier trough.

14. A bicycle carrier apparatus including:
a longitudinal member having a reduced friction member operatively associated with one end thereof;
at least one rigid mechanical member attached to and extending in a generally perpendicular direction from the longitudinal member;
at first adjustable component to releasably secure a rear wheel of a bicycle relative to at least the longitudinal member; and
a second component to releasably secure a front wheel of the bicycle relative to at least the longitudinal member.

15. The bicycle carrier apparatus of claim 14, where the front wheel of the bicycle is detached from forks of the bicycle while releasably secured to the bicycle carrier.
